(19) United States
(12) Patent Application Publication
(10) Pub. No.: US 2012/0323723 A1
(43) Pub. Date: Dec. 20, 2012

(54) Method and System for Dynamically Determining the Sales Price of Custom Retail Products

(76) Inventors: Kenneth J. Susnjara, Birdseye, IN (US); Lawrence Epplin, Dale, IN (US)

(21) Appl. No.: 13/162,987

(22) Filed: Jun. 17, 2011

(51) Int. Cl. G06Q 30/00; B23P 17/04

(52) U.S. Cl. 705/26.5; 705/306; 29/592; 29/428; 29/650

(57) ABSTRACT

A method for dynamically determining the sales price of a product composed of a number of components produced from at least one workpiece of selected dimensions, including indicating the specifications of such product, determining the number and configurations of the components of such product, determining the minimum number of such workpieces required to provide the determined number of such components by efficiently nesting such components on a minimum number of such workpieces and computing the sales price of such product partially based on the determined minimum number of such workpieces required to most efficiently yield such components.

This invention relates to a method and system for producing a product and more particularly to such a method and system for dynamically determining the sales price of custom forms of such a product.

### BACKGROUND OF THE INVENTION

Products of the type shown in FIG. 1 of the drawings, formed of a number of component panels as shown in FIG. 2, typically are fabricated by cutting the various panels as shown in FIG. 2 from sheets of material as shown in FIG. 3, consisting of wood or a composite material, providing edge-banding to certain ones of such panels, assembling such panels together, finishing the assembled structures and then attaching various hardware including slides, handles, knobs and the like. Often, such panels are formed on CNC router machines through the use of computer-aided software utilizing various algorithms which function to determine the configuration of each of such panels, provide a nesting pattern of such component panels on one of more sheets of material of given dimensions to generate an optimal usage of such material and provide a cutting pattern for a tool used to form such panels. Such panels may be assembled by the use of various means including interlocking surfaces, adhesive materials, metallic fasteners and the like, including a combination of such types of fasteners, and may be finished by painting, staining and the like.

Traditionally, in the type of product shown in FIG. 1, the specifications of the product are standardized and the product is manufactured in some quantity, sold to a retailer and then resold to end users, or the specifications are customized and the product is manufactured to such specifications in usually a single or other limited quantity, and sold to such customer. More recently, methods have been developed to permit a prospective purchaser of such a product to acquire a product as described from a retailer, designed to the customers specification with certain constraints. The use of such methods, however, has been hindered by the amount of time required to generate a sales price of the specified product, often resulting in a loss of interest on the part of the prospective purchaser. Accordingly, it is the principal object of the present invention to provide a method and system for dynamically determining the sales price of a custom form of such type of product.

### SUMMARY OF THE INVENTION

The principal object of the present invention is achieved by providing for a method and system permitting a prospective purchaser of a particular product from a retail establishment to determine the specifications of such product and obtain a prompt quotation of a price for such specified product, comprising indicating the specifications of such a product, determining the number and configurations of the components of such product, determining the minimum number of workpieces required to provide the determined number of such components by efficiently nesting such components on a minimum number of such workpieces and computing the sales price of such product partially based on the predetermined minimum number of such workpieces required to efficiently yield such components. In a preferred embodiment of the invention, such determinations and computations are performed by a computer programmed with, applicable algorithms, the identification of the product and the designation of the specifications are effected by means of a touch screen of a computer monitor, the algorithms of the operating program are functional to determine and calculate the dimensions of the components of the product, the number of workpieces required to produce such components, a nesting pattern of such components, the amount of time required to machine such components, the cost of the components based on the determined nesting pattern and machining times of the nested pattern, and display the sales price on the monitor of the computer. In addition, it is contemplated that the algorithm functional to determine the nesting pattern of the components of the product be comparable to the algorithm functional in determining the nesting function in the operation of a machine used to produce such components, and the operating program be functional to permit an adjustment or alternation of the specifications of the components of the product and repeat the determination and calculation functions to provide a revised sales price based on such revised specifications.

### BRIEF DESCRIPTIONS OF THE DRAWINGS

FIG. 1 is a perspective view of a custom made product in the form of a cabinet, the method and system of pricing of which is provided by the present invention;

FIG. 2 is a perspective view of the cabinet shown in FIG. 1, illustrating the components thereof in exploded relation;

FIG. 3 is a top plan view of a sheet of material from which the components of the cabinet shown in FIG. 2 are produced, illustrating the nesting pattern of such components;

FIG. 4 is a schematic of a system which may be utilized to custom produce the component parts shown in FIG. 2; and

FIG. 5 is a flow diagram of the method used with the system shown in FIG. 4 within the scope of the present invention.

### DETAILED DESCRIPTION OF THE PREFERRED EMBODIMENTS OF THE INVENTION

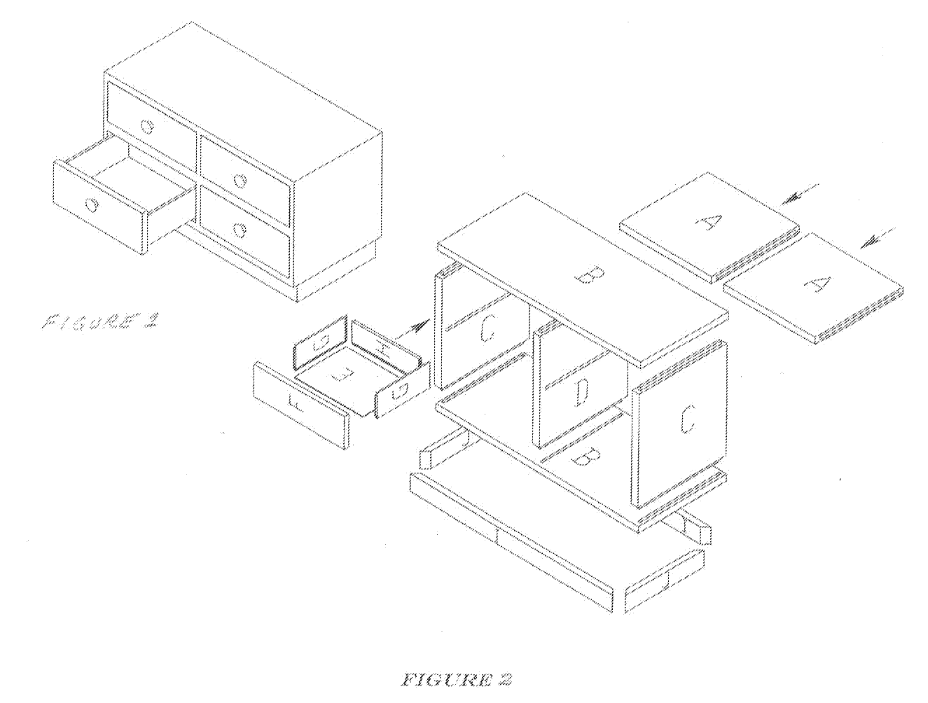

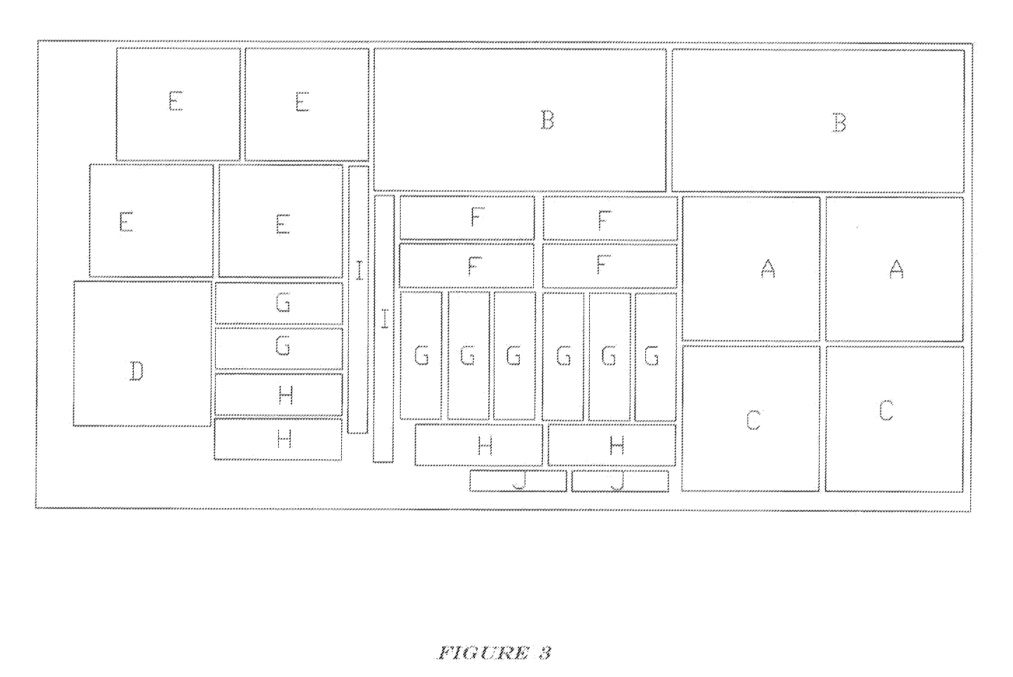

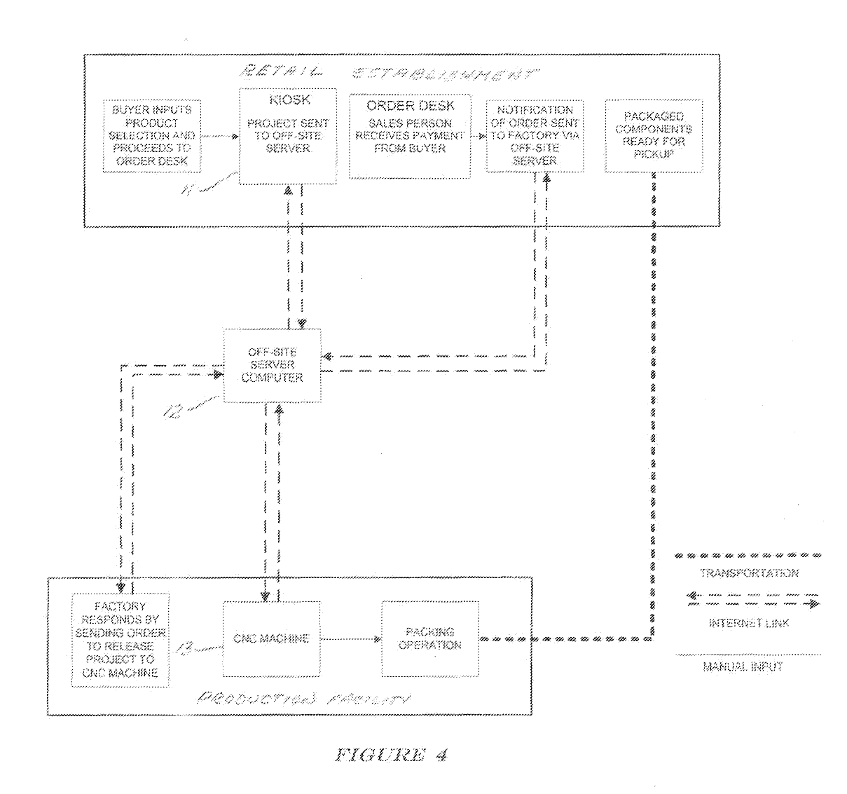

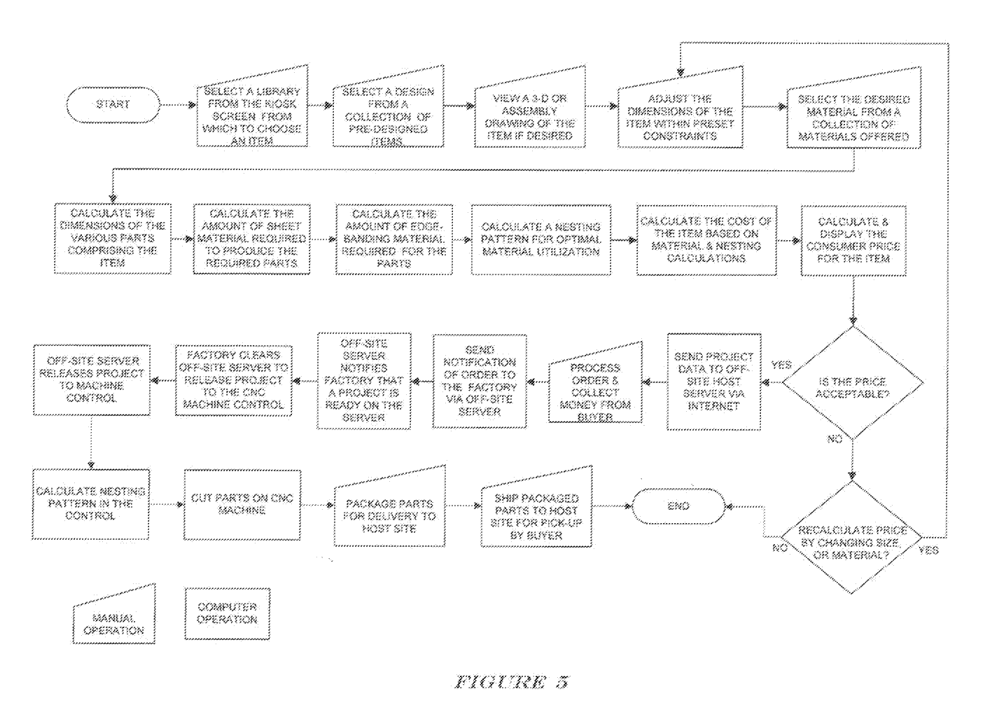

Referring to the drawings, there is shown in FIG. 4 a system which when operated by means of the method shown in FIG. 5 is functional to produce a product as shown in FIG. 1 from a number of panels shown in FIG. 2, within the scope of the present invention. The system includes a kiosk 10, a server computer 11 and a GNG router machine 12. The kiosk is located at a retail establishment frequented by prospective purchasers, the server computer is located at an off-site location and the CNG router machine is located at an off-site production facility. The kiosk is provided with a monitor including a touch screen which is operatively connected to the server computer, the CNC router machine is provided with a controller and the computer is provided with a suitable program which is functional to display on demand by a user, a library of products such as the product shown in FIG. 1, permit a selection of one of such products, display a selected product, indicate the dimensions of the displayed product, indicate the sales price of the selected product based on predetermined material and labor costs, overhead expenses and profit, permit an adjustment of the dimensions of the selected product and recompute the sales price of the selected product on the basis of the adjusted dimensions and repeatedly recompute the sales price of the selected product upon further adjustment of the dimensions thereof. For recomputing the sales price of a selected product in which the dimensions are adjusted, the program includes various algorithms which function to determine the number and dimensions of the component panels as shown in FIG. 2 required assemble the product as shown in FIG. 1, a nesting pattern of the component panels on one more sheets of the material as shown in FIG. 3, providing for optimal usage of such material, and displaying a revised sales price based on the adjusted dimensions of such product. Upon acceptance of a sales price computed and consummation of a purchase of the component panels, the computer functions to notify the production facility of the order and transmit programmed cutting instructions for producing the component panels of the product to the controller of the CNC router machine at such facility.

The kiosk preferably would be located in a public area of the retail establishment, readily accessible to prospective purchasers and in the vicinity of an order desk staffed by sales personnel. The establishment also would be provided with a designated area where ordered panels could be collected by a purchaser. The production facility can be located on the premises, of the retail establishment, nearby such establishment or at a remote site. Such facility may consist of a production department and a packaging and shipping department, and additionally may include a finishing department in which the formed panels would be assembled and finished and hardware would be installed to provide a finished product as shown in FIG. 1. The computer also may be located at the premises of the retail establishment, at the production facility or at a third site and be connected to the monitor of the kiosk and the controller of the CNC router machine at the production facility by hardwire, internet links and combinations thereof.

Referring to FIG. 5, in the use of the system as shown in FIG. 4, a prospective purchaser interested in the purchase of a set of panels as shown in FIG. 2 to assemble a product as shown in FIG. 1 would utilize the touch screen at kiosk 10 to display a library of available products including the product shown in FIG. 1. Upon viewing such library of products, the purchaser would select a particular product and so indicate on the touch screen. The screen would then display a three dimensional view and/or an assembly drawing of the selected product. The purchaser then would be permitted by the use of the touch screen to adjust any of the dimensions of the selected product displayed on the screen, within certain constraints. Upon completion of the selection of the product and the adjustment of the dimensions of such product, the purchaser would select a material from a list of materials displayed on the screen and then indicate to the computer the completion of the selection process.

The computer would then operate to calculate the dimensions of the component parts of the selected product, the amount of sheet material required to produce the required parts, the amount of edge-banding material required for such parts, a nesting pattern of the required component panels for optimal material utilization and the cost of the product based on such material and nesting calculations. The sales price of the item would then be displayed on screen for the purchaser. At such juncture, the purchaser would have the options of accepting the price, adjusting the dimensions of the product and causing the computer to recalculate the sales price and simply discontinuing the procedure whereupon the computer procedure would discontinue after a certain time interval.

Upon initially or ultimately accepting a sales price indicated on the screen of the monitor, the pertinent project data would be sent to computer 11 and the purchaser would consummate the purchase with a salesperson at an order desk in the vicinity of the kiosk. The server would then notify the production facility that the production data is available at the server computer permitting the production facility to receive the project and input such data into the controller of CNC router machine 12 for the purpose of producing the ordered panels. Upon the controller calculating the nesting pattern of the parts as shown in FIG. 3 and suitable sheets of material being loaded on the workbed of the CNC router machine, the machine is operated to form such parts. The parts thus produced are packaged at the production facility and transported back to the retail establishment for delivery to the purchaser.

Optionally, upon the decision of the purchaser, the component panels thus formed may be assembled, finished and provided with suitable hardware by personnel at the production facility to provide a finished product as shown in FIG. 1 which would be transported to the retail establishment for delivery to the purchaser. As a further option, the component panels formed by the production facility may be assembled, finished and provided with suitable hardware by personnel of the retail establish mentor another subcontractor of the retail establishment.

Typically, the component parts of such a product would consist of panels produced from sheets of material of selected dimensions. Such materials may consist of wood, composite materials and other suitable materials. The purchaser would have the option of simply purchasing the components of a selected product which such person would undertake to assemble or to purchase the assembled product. In either instance, the purchaser would be able to make a selection of the design of the product, the dimensions of the selected product and the assembled or disassembled components of such product, and be informed of a monetary indication of the cost of the purchase. The purchaser further would have the ability to repeatedly adjust the dimensions of the selected product and have the sales price recomputed in the same short amount of time.

In lieu of the use of a kiosk with a monitor providing a touch screen located at the premises of a retail establishment the procedure as described may be modified through the use of the internet, providing suitable means for making the selection process with the use of a computer at the site of the prospective purchaser.

The system and method described not only allows a prospective purchaser to specify the dimensions of a customized product but to easily and rapidly adjust such dimensions and provide an immediate indication of the revised sales price of the selected product which accommodates the purchaser and enhances the sales of the retail establishment.

From the foregoing detailed description, it will be evident that there are a number of changes, adaptations and modifications of the present invention, which come within the province of those persons having ordinary skill in the art to which the aforementioned invention pertains. However, it is intended that all such variations not departing from the spirit of the invention be considered as within the scope thereof as limited solely by the appended claims.

I claim:

1. A method for dynamically determining the sales price of a product composed of a number of components produced from at least one workpiece of selected dimensions, comprising:
indicating the specifications of said product;
determining the number and configurations of the components of said product;
determining the minimum number of said workpieces required to provide the determined number of said components by efficiently nesting said components on a minimum number of said workpieces; and
computing the sales price of said product partially based on the determined minimum number of said workpieces required to most efficiently yield said components.

2. The method according to claim 1 wherein said determinations and computations are conducted by a computer programmed with applicable algorithms.

3. The method according to claim 2 wherein identification of said product is effected by means of a touch screen.

4. The method according to claim 2 wherein the algorithms functional to determine said nesting are comparable to the algorithms functional in determining the nesting function in the operation of a machine used to produce such components.

5. The method according to claim 4 wherein said algorithms are functional to calculate the dimensions of said components, the number of said workpieces required to produce said components and a nesting pattern of said components with respect to said workpieces.

6. The method according to claim 5 wherein said algorithms are functional to calculate the amount of time required to machine said components.

7. The method according to claim 5 wherein one of said algorithms is functional to calculate the costs of said components based oh the calculated nesting pattern and machining time of said nesting pattern.

8. The method according to claim 2 including displaying said price.

9. The method according to claim 7 including altering at least one dimension of said product and repeating said determination and calculation functions.

10. The method according to claim 9 including displaying any revised sales price predicated on having altered at least one dimension of said product.

11. The method according to claim 1 including utilizing an off-site personal computer linked to an off-site server computer through the internet.

12. A method of producing the components of a product to custom specifications, produced from at least one workpiece of selected dimensions, comprising:
indicating the specification of said product;
determining the number and configuration of the components of said product;
determining the minimum number of said workpieces required to provide the determined number of said components by efficiently nesting said components on a minimum number of said workpieces;
computing the sales price of said product partially based on the determined number of said work pieces required to most efficiently yield said components; and
forming said components,

13. A method of producing a product to custom specifications, formed of components produced from at least one workpiece of selected dimensions, comprising:
indicating the specifications of said product;
determining the number and configuration of the components of said product;
determining the minimum number of said workpieces required to provide the determined number of said components by efficiently nesting said components on a minimum number of said workpieces;
computing the sales price of said product partially based on the determined number of said workpieces required to most efficiently yield said components;
forming said components; and
assembling said formed components to provide said product.

14. A system for dynamically determining the sales price of a product composed of a number of components produced from at least one workpiece of selected dimensions, comprising:
means for indicating the specifications of said product;
means for determining the number and configurations of the components, of said product;
means for determining the minimum number of said workpieces required to provide the determined number of said components by efficiently nesting said components on a minimum number of said workpieces; and
means for computing the sales price of said product partially based on the determined minimum number of said workpieces required to most efficiently yield said components.

15. A system according to claim 14 wherein said means for determining and computing comprise a computer program with applicable algorithms.

16. A system according to claim 15 including a touch screen functional to display a library of products and selected ones of said products, and input data relating to selected specifications of selected products.

17. A system according to claim 16 wherein said touch screen is provided in a kiosk disposed at a location accessible to perspective users of said system.

18. A system according to claim 17 wherein said kiosk is disposed at a retail establishment frequented by prospective purchasers of said products.

19. A system according to claim 15 wherein said algorithm functional to determine said nesting pattern is comparable to an algorithm functional in determining the nesting pattern in the operation of a CNC machine used to produce said components.

20. A system according to claim 15 wherein said algorithms are functional to calculate the dimensions of said components, the number of said workpieces required to produce said components and for obtaining an optimal yield of said workpieces relative to said number of said workpieces.

21. A system according to claim 20 wherein one of said algorithms is functional to calculate the cost of said components based on the calculated nesting pattern and the time for machining said pattern of nested components.

22. A system according to claim 20 including means for displaying said sales price on said touch screen.

23. A system according to claim 16 including means for altering at least one dimension of said product and repeating said determination and calculation functions.

24. A system according to claim 14 including an on-site computer linked to an off-site computer through the internet wherein data is inputted and displayed with said on-site computer and data is processed by said off site computer.

25. A system for producing the components of a product to custom specifications, produced from at least one workpiece of selected dimension; comprising:
means for indicating the specifications of said product;
means for determining the number and configuration of the component of said product;
means for determining the minimum number of said workpieces required to provide the determined number of said components by efficiently nesting said components on a minimum number of said workpieces;
means for computing the, sales price of said product partially based on the determined minimum number of said workpieces required to most efficiently yield said components; and
means for forming said components.

26. A system for producing a product to custom specifications, formed of components produced from at least one workpiece of selected dimension, comprising:
means for indicating the specifications of said product;
means for determining the number and configuration of the components of said product;
means for determining the minimum number of said workpieces required to provide the determined number of said components by efficiently nesting said components on a minimum number of said workpieces;
means for computing the sales price of said product partially based on the determined minimum number of said workpieces required to most efficiently yield said components;
means for forming said components; and
means for assembly said components to form said product.
